(19) United States
(12) Patent Application Publication
(10) Pub. No.: US 2017/0161636 A1
(43) Pub. Date: Jun. 8, 2017

(54) BEHAVIOR ANALYSIS LEARNING SYSTEM BASED THEREON AND METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN LU, Shenzhen (CN); HUAN-HUAN ZHANG, Shenzhen (CN); XUE-SHUN LIU, Shenzhen (CN); YU-YONG ZHANG, Shenzhen (CN)

(21) Appl. No.: 15/138,227

(22) Filed: Apr. 26, 2016

(30) Foreign Application Priority Data
Dec. 3, 2015 (CN) 201510875534.3

(51) Int. Cl. G06N 99/00; G06N 5/04

(52) U.S. Cl. CPC G06N 99/005; G06N 5/04

(57) ABSTRACT

A learning system based on behavior analysis includes a plurality of collecting terminals and a server coupled to the plurality of collecting terminals. The server obtains at least one related group within the plurality of data-collecting terminals and information as to user demands relevant to the at least one related group. The demands information is analyzed to determine a triggering event and a corresponding triggering result and the system monitors whether information collected by a collecting terminal is in accord with a triggering event. A triggering result corresponding to the trigger event is executed when the information collected by a collecting terminal is in accord with the triggering event. A behavior analysis learning method is also provided.

### CROSS-REFERENCE TO RELATED APPLICATIONS

This application claims priority to Chinese Patent Application No. 201510875534.3 filed on Dec. 3, 2015, the contents of which are incorporated by reference herein.

### FIELD

The subject matter herein generally relates to data analysis and more particularly to a method and learning system based on the behavior analysis.

### BACKGROUND

Smart home systems are popular and the Internet of things is developing rapidly. However, the existing Internet of things technology is dependent on pre-prepared programs to achieve intelligent and worthwhile offers to users.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a diagram of an application environment of a behavior analysis learning system of an embodiment.

FIG. 2 is a function module diagram of the behavior analysis learning system of FIG. 1.

FIG. 3 is a diagram of an example embodiment of a user interface of the behavior analysis learning system of FIG. 1.

FIG. 4 is a diagram of an example embodiment of data analysis process of the behavior analysis learning system of FIG. 1.

FIG. 5 is a flowchart of an analysis learning method for the behavior analysis learning system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to offer a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like. In general, the word “module”, as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

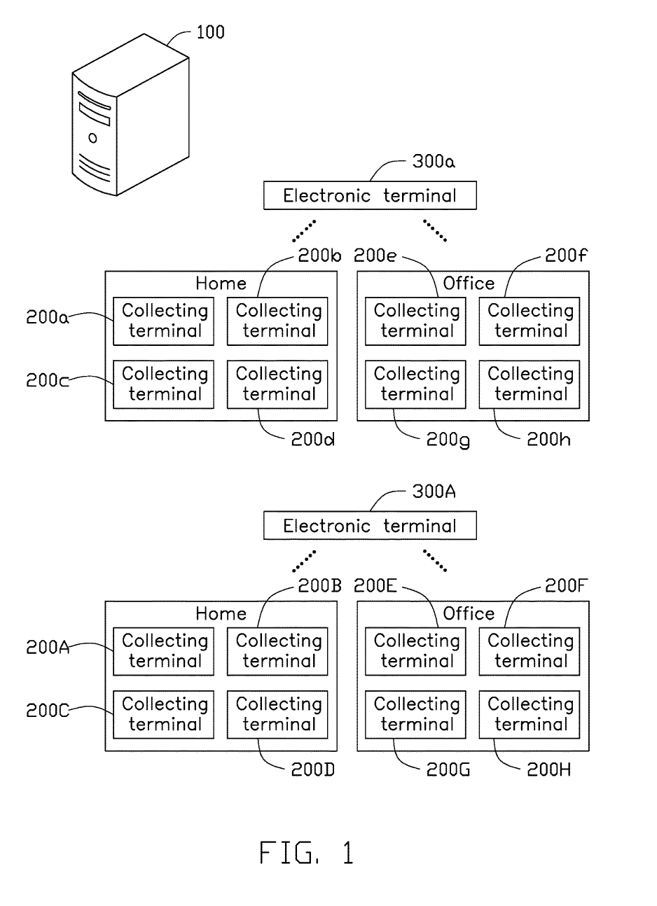

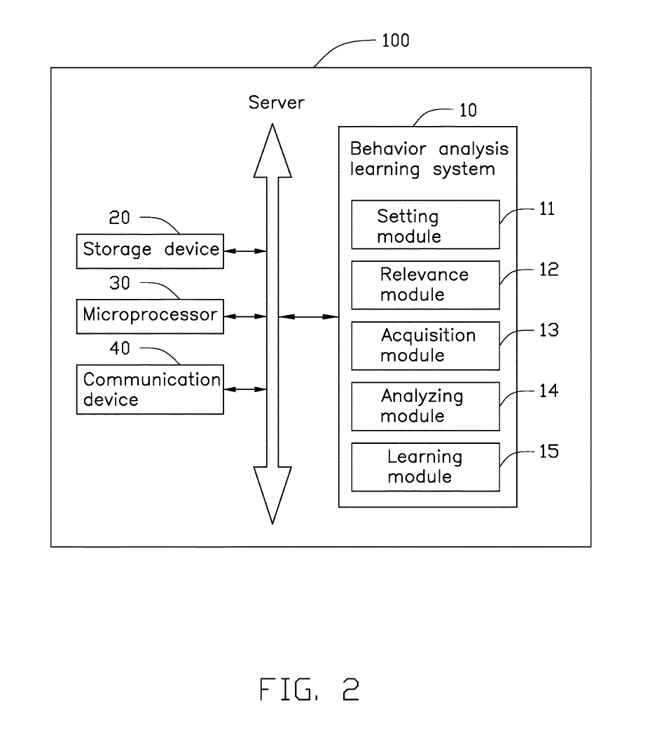

FIG. 1 illustrates an application environment of a behavior analysis learning system 10. FIG. 2 illustrates a function module diagram of the behavior analysis learning system 10. The behavior analysis learning system 10 is installed and runs in a server 100 which can be connected with multiple collecting terminals, 200A-200H and 200a-200h, and multiple electronic terminals, 300A, 300a.

The multiple collecting terminals 200A-200H, 200a-200h can be multiple terminals in a home for collecting daily information, or can be multiple terminals in multiple homes for collecting similar information. The multiple electronic terminals 300A, 300a can be configured to be added to or be set up with the multiple collecting terminals 200A-200H, 200a-200h. In at least one embodiment, the multiple collecting terminals 200A-200H, 200a-200h can be temperature sensors, cameras, humidity sensors, clocks, air-conditioning remote controls, or television remote controls. The multiple collecting terminals 200A-200H, 200a-200h also can be articles with electronic tags, such as clothes, desks, or key rings. The multiple electronic terminals 300A, 300a can be electronic devices, such as telephones, touch panels, or notebooks. The multiple electronic terminals 300A, 300a can obtain information from the server 100. In at least one embodiment, the multiple electronic terminals 300A, 300a also can be collecting terminals configured to collect information, such as positional or geographical locations of the electronic terminals 300A, 300a.

FIG. 2 illustrates an embodiment of the server 100. The server 100 can include a storage device 20, a microprocessor 30, and a communication device 40. In at least one embodiment, the storage device 20 can be a random access memory (RAM) for temporary storage of information, and/or a read only memory (ROM) for permanent storage of information. In at least one embodiment, the storage device 20 also can be an external storage device, such as an external hard disk or a storage card. The microprocessor 30 is coupled to the storage device 20 and the communications device 40. The communications device 40 allows the multiple collecting terminals 200A-200H, 200a-200h to couple to the electronic terminals 300A, 300a. In at least one embodiment, the behavior analysis learning system 10 can be stored in the storage device 20 and executed by the microprocessor 30.

In at least one embodiment, the behavior analysis learning system 10 can include a module or multiple modules stored in the storage device 20 and under the control of the microprocessor 30. For example, the behavior analysis learning system 10 can include a setting module 11, a relevance module 12, an acquisition module 13, an analyzing module 14, and a learning module 15. In at least one embodiment, the setting module 11, the analyzing module 12, the acquisition module 13, and the analyzing module 14 can be comprised of computerized instructions in the form of one or more computer-readable programs stored in the storage device 20 and executed by the microprocessor 30.

In at least one embodiment, the setting module 11 can offer a user interface for adding multiple collecting terminals 200A-200H, 200a-200h and set up at least one related group, related by relevance, between multiple collecting terminals 200A-200H, 200a-200h. Each related group can include at least one event relevant to the related group or multiple collecting terminals related to the at least one event. In least one embodiment, the user interface also can be used to set user permissions.

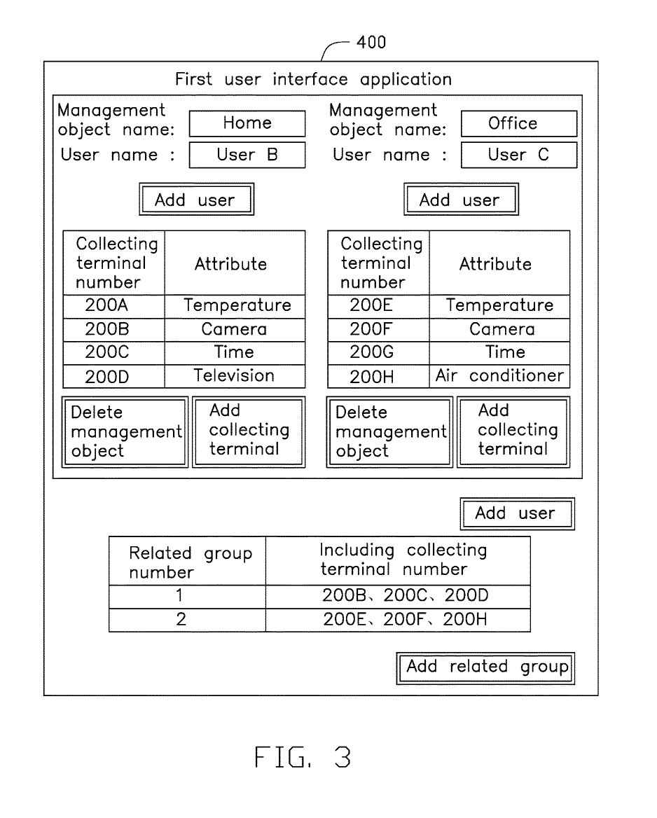

FIG. 3 illustrates the electronic terminals 300A, 300a. The user interface can be configured for a user A to add an article, for example, a home or office article. The user interface also can be used to set user permissions, for example, a user permission of the home of B is user B, and other users receiving home permissions may be users C and D. In addition, the user interface also can function as the collecting terminals at the home, that is, the collecting terminals 200A-200D, 200a-200d. The collecting terminals in the office are the collecting terminals 200E-200H, 200e-200h. The user interface also can set attributes of the collecting terminals 200A-200H, 200a-200h and build at least one related group related by relevance between the multiple collecting terminals 200A-200H, 200a-200h.

In at least one embodiment, the collecting terminals 200A, 200E can be temperature sensors to obtain environment temperature. The collecting terminals 200B, 200F can be cameras to capture images. The collecting terminals 200C, 200G can be clocks to indicate date and time. The collecting terminal 200D is a television remote control to indicate a state of a television, such as the television being turned on or turned off. The collecting terminal 200H is an air conditioning remote control to indicate a state of an air conditioner, such as the air conditioner being turned on or turned off. In at least one embodiment, the colleting terminals can be added to and not be limited to the collecting terminals 200A-200H, 200a-200h. In at least one embodiment, a first related group can include the related collecting terminals 200B, 200C, 200D; and the second related group can include the related collecting terminals 200E, 200F, 200H.

The relevance module 12 can obtain user settings from the user interface, and set a related list in the storage device 20 according the related group. In at least one embodiment, the relevance module 12 can set a related list according the first related group and the second related group, or add the first related group and the second related group to the existing related list.

The acquisition module 13 can obtain the data collected from each of collecting terminals 200A-200H, 200a-200h. In at least one embodiment, the acquisition module 13 obtains the data collected from each of collecting terminals 200A-200H, 200a-200h at preset times.

The analyzing module 14 can analyze the data collected by each of collecting terminals 200A-200H, 200a-200h to determine at least one triggering event and at least one triggering result corresponding to the triggering event. In at least one embodiment, the analyzing module 14 is configured to analyze the data collected from the acquisition module 13 at the present moment and at a previous moment according to the statistics principle to determine at least one triggering event and at least one triggering result corresponding to the triggering event.

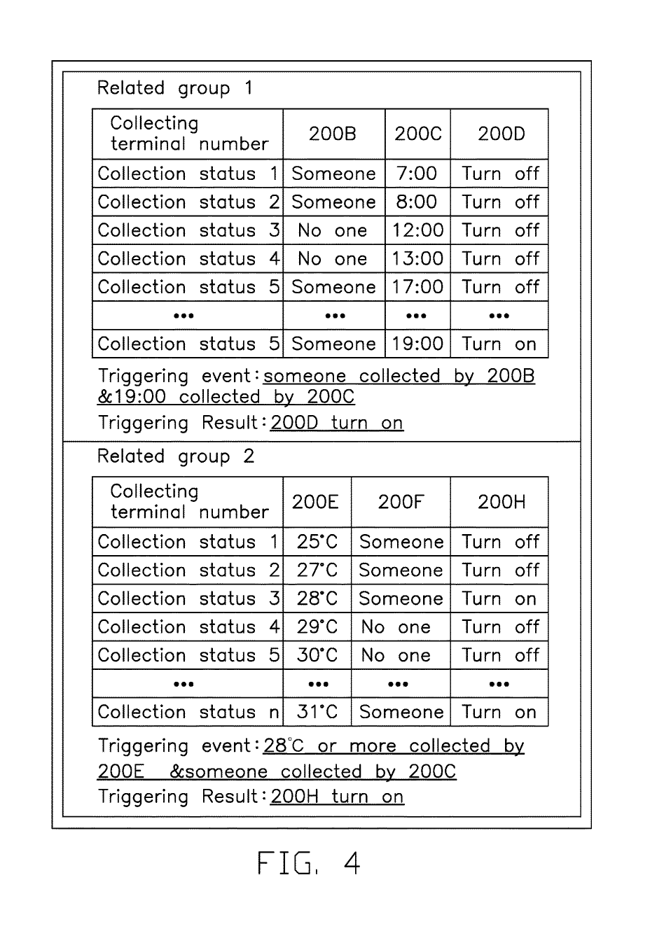

FIG. 4 illustrates data analysis of the behavior analysis learning system. The analyzing module 14 is configured to analyze the data collected from collecting terminals 200B-200D, and determine the triggering event. A user action may be collected by the collecting terminal 200B, the time of the collection according to the collecting terminal 200C being 19:00, and the triggering result is determined as being that the collecting terminal 200D is turned on. This means that a user is in the house and that the television is turned on. The analyzing module 14 is configured to analyze the data collected from collecting terminals 200E, 200F, and 200H, and determine the triggering event. For example, the current temperature collected by the collecting terminal 200E is more than 28° C. and a user action is collected by the collecting terminal 200F. The triggering result is that the 200H device is turned on because a user is in the office and the air conditioner has been turned on.

If the information collected by a collecting terminal is in accord with a triggering event, the learning module 15 can offer a guide or suggestion or send a control instruction to a collecting terminal to execute a certain triggering result.

The learning module 15 can learn the behavior of users, and offer guides or suggestions as to controls by users according the learning outcome. For example, if the analyzing module 14 analyzes that user A switches on the television at his home at seven o'clock every night, where data collected by the collecting terminal determines that a user is in a house at 19:00, the learning module 15 will send a message to or suggest to user A that the television can be turned on, or even turn the television on directly, according the analysis result of the analyzing module 14. In at least one embodiment, if user A is the author of a triggering event when the presence of someone is detected by collecting terminal 200B of the first related group, and the current time collected by the 200C of the first related group is 19:00, the learning module 15 will issue a guide or suggestion to user A to suggest turning on the television, or send a control instruction to directly turn on the television.

On the other hand, if the analyzing module 14 analyzes that the user A will open the air conditioner at the office when the temperature is more than 28° C., and when an office user is found to be user A by the collecting terminal and the temperature is more than 28° C., the learning module 15 will send a message to suggest that the user should turn on the air conditioner, or can turn on the air conditioner directly, according to analysis of the behavior of user A by the analyzing module 14.

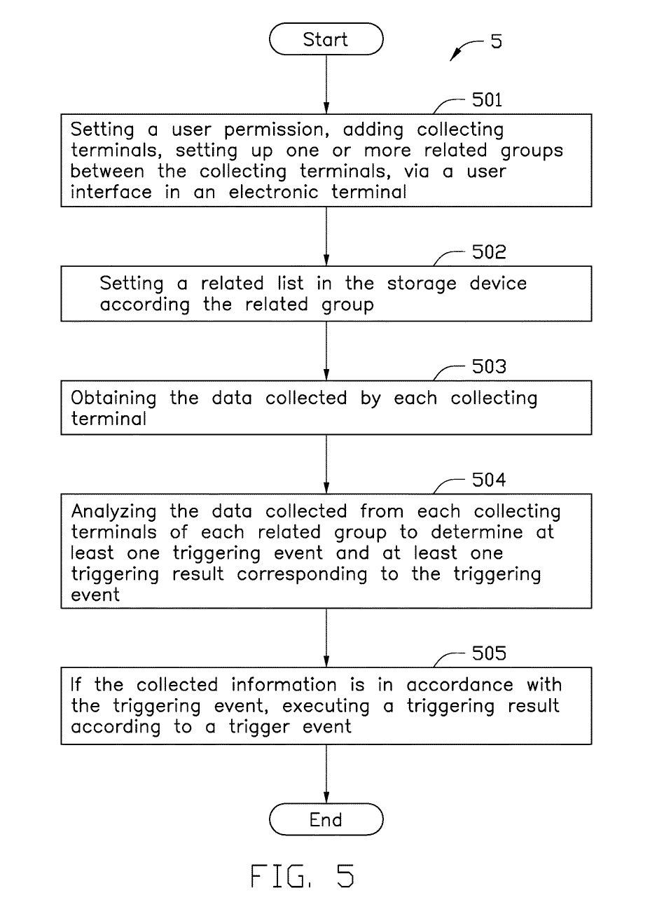

FIG. 5 shows a flowchart presented in accordance with an example embodiment.

At block 501, setting a user permission, adding collecting terminals, setting up one or more related groups between the collecting terminals, via a user interface in an electronic terminal.

At block 502, setting a related list in the storage device according the related group.

At block 503, obtaining the data collected by each collecting terminal.

At block 504, analyzing the data collected from each collecting terminals of each related group to determine at least one triggering event and at least one triggering result corresponding to the triggering event.

At block 505, if the collected information is in accordance with the triggering event, executing a triggering result according to a trigger event.

The embodiments shown and described above are only examples. Many details are often found in the art such as the other features of a behavior analysis learning system and method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A behavior analysis learning system comprising:
a server coupled with a plurality of collecting terminals;
a relevance module configured to set a related list in a storage device, the related list comprising a plurality of related groups;
an acquisition module configured to obtain data collected by each of the collecting terminals;
an analyzing module configured to analyze the data collected by each collecting terminal to determine at least one triggering event and at least one triggering result; and
a learning module configured to execute a triggering result according to the triggering event, wherein the triggering event is based on the collected information.

2. The behavior analysis learning system of claim 1, wherein the behavior analysis learning system further comprises a setting module configured to offer a user interface for adding multiple collecting terminals, and set at least one related group according to relevance between multiple collecting terminals.

3. The behavior analysis learning system of claim 1, wherein the behavior analysis learning system further comprises a setting module is configured to offer a user interface for adding user permissions.

4. The behavior analysis learning system of claim 1, wherein the acquisition module obtains the data collected by each collecting terminals every preset time, the analyzing module is configured to analyze the data collected from the acquisition module at the present moment and at the previous moment to determine at least one triggering event and at least one triggering result.

5. The behavior analysis learning system of claim 4, wherein the analyzing module analyzes the data according the statistics principle.

6. A behavior analysis learning method, comprising:
(a) obtaining a related list in a sever, the related list comprising a plurality of related group;
(b) obtaining the data collected by each collecting terminal;
(c) analyzing the data collected by collecting terminals of each related group to determine at least one triggering event and at least one triggering result according to the corresponding triggering event; and
(d) offering a guide suggestion or executing a triggering result according to the trigger event, when the collect information is accord with the triggering event.

7. The behavior analysis learning method of claim 6, wherein before the step (a) comprises following step (e): offering a user interface for adding multiple collecting terminals, and setting at least one related group according to relevance between multiple collecting terminals.

8. The behavior analysis learning method of claim 7, wherein the step (e) comprises following step (e1): setting a user permission via the user interface.

9. The behavior analysis learning method of claim 6, wherein the step (b) comprises: obtaining the data collected by each collecting terminals every preset time, and the step (c) comprises: analyzing the data collected from the acquisition module at the present moment and at the previous moment to determine at least one triggering event and at least one triggering result.

10. The behavior analysis learning method of claim 9, wherein the analyzing module analyzes the data according the statistics principle.

11. A sever module comprising:
a sever coupled with a plurality of collecting terminals; and
a behavior analysis learning system comprising:
a relevance module configured to set a related list in a storage device, and the related list comprising a plurality of related groups;
an acquisition module configured to obtain data collected by each of the collecting terminals;
an analyzing module configured to analyze the data collected by each collecting terminal to determine at least one triggering event and at least one triggering result; and
a learning module configured to execute a triggering result according to the triggering event, wherein the triggering event is based on the collected information.

12. The sever module of claim 11, wherein the behavior analysis learning system further comprises a setting module configured to offer a user interface for adding multiple collecting terminals, and set at least one related group according to relevance between multiple collecting terminals.

13. The sever module of claim 11, wherein the behavior analysis learning system further comprises a setting module is configured to offer a user interface for adding user permissions.

14. The sever module of claim 11, wherein the acquisition module obtains the data collected by each collecting terminals every preset time, the analyzing module is configured to analyze the data collected from the acquisition module at the present moment and at the previous moment to determine at least one triggering event and at least one triggering result.

15. The sever module of claim 14, wherein the analyzing module analyzes the data according the statistics principle.
